(19) United States
(12) Patent Application Publication
(10) Pub. No.: US 2024/0100731 A1
(43) Pub. Date: Mar. 28, 2024

(54) CHAINSAW CUTTERS

(71) Applicant: MILWAUKEE ELECTRIC TOOL CORPORATION, Brookfield, WI (US)

(72) Inventors: Ian H.A. Blair, Wauwatosa, WI (US); Julian L. Kinneavy, Sussex, WI (US)

(21) Appl. No.: 18/474,346

(22) Filed: Sep. 26, 2023

Related U.S. Application Data
(60) Provisional application No. 63/410,040, filed on Sep. 26, 2022.

(51) Int. Cl. B27B 33/14; B23K 26/354; B23P 15/28

(52) U.S. Cl. CPC B27B 33/142; B23K 26/354; B23P 15/28

(57) ABSTRACT

A chainsaw cutter for a chainsaw chain. The chainsaw cutter includes a cutter body having a pair of rivet holes extending through the cutter body. The chainsaw cutter further includes a cutting tooth coupled to and extending from an upper portion of the cutter body. The cutting tooth is configured to cut a workpiece during a cutting operation. Moreover, the chainsaw cutter includes a feed limiter coupled to and extending from the upper portion of the cutter body, and a gullet disposed between the cutting tooth and the feed limiter. The cutting tooth is formed on the cutter body by additive manufacturing.

### CROSS-REFERENCE TO RELATED APPLICATIONS

The present application claims priority to U.S. Provisional Patent Application No. 63/410,040 filed Sep. 26, 2022, the entire content of which is incorporated herein by reference.

### FIELD OF THE INVENTION

The present invention relates to chainsaw chains, and in particular a chainsaw cutter.

### BACKGROUND OF THE INVENTION

A chainsaw chain typically includes cutters, drive links, tie straps, and rivets. The components of the chainsaw chain may be coupled to each other in various patterns and rotatably driven along a guide bar of a chainsaw to perform cutting operations. The cutters can have different configurations to provide a chainsaw chain capable of being used in different cutting environments.

### SUMMARY OF THE INVENTION

The present invention provides, in one aspect, a chainsaw cutter for a chainsaw chain. The chainsaw cutter includes a cutter body having a pair of rivet holes extending through the cutter body. The chainsaw cutter further includes a cutting tooth coupled to and extending from an upper portion of the cutter body. The cutting tooth is configured to cut a workpiece during a cutting operation. Also, the chainsaw cutter includes a feed limiter coupled to and extending from the upper portion of the cutter body. The feed limiter is spaced from the cutting tooth. Moreover, the chainsaw cutter includes a gullet disposed between the cutting tooth and the feed limiter. The cutting tooth is formed on the cutter body by additive manufacturing.

The present invention provides, in another aspect, a chainsaw chain for a chainsaw. The chainsaw chain includes a plurality of drive links configured to connect the chainsaw chain to the chainsaw. Each drive link includes a drive link body, a rivet hole extending through the drive link body, and a tang extending from the drive link body and configured to engage a drive element of the chainsaw chain. The chainsaw chain further includes a plurality of cutters configured to cut a workpiece during a cutting operation. Each cutter includes a cutter body having a pair of rivet holes extending through the cutter body, and a cutting tooth coupled to and extending from an upper portion of the cutter body. Each cutter further includes a feed limiter coupled to and extending from the upper portion of the cutter body, and a gullet disposed between the cutting tooth and the feed limiter. The feed limiter is spaced from the cutting tooth. The cutting tooth is formed on the cutter body by additive manufacturing. Moreover, the chainsaw chain includes a plurality of rivets received within corresponding rivet holes of the plurality of drive links and the plurality of cutters to couple the plurality of drive links and the plurality of cutters together.

The present invention provides, in another aspect, a method of manufacturing a chainsaw chain for a chainsaw. The method includes providing a plurality of drive links. Each drive link includes a drive link body, a rivet hole extending through the drive link body, and a tang extending from the drive link body and configured to engage a drive element of the chainsaw. The method further includes providing a plurality of cutters. Each cutter includes a cutter body having a rivet hole extending therethrough. The method also includes forming a cutting tooth on the cutter body of at least one of the plurality of cutters by additive manufacturing. Moreover, the method includes inserting a rivet into the rivet hole of each drive link and the rivet hole of each cutter to couple the plurality of drive links and the plurality of cutters together.

### BRIEF DESCRIPTION OF DRAWINGS

FIG. 1 is a perspective view of a chainsaw.

FIG. 2 is a perspective view of a chainsaw chain according to an embodiment of the present invention.

FIG. 3 is a front view of the chainsaw chain of FIG. 2.

FIG. 4 is a perspective view of a drive link according to an embodiment of the present invention.

FIG. 5 is a perspective view of a tie strap according to an embodiment of the present invention.

FIG. 6 is a side view of a cutter according to an embodiment of the present invention.

FIG. 7 is a front view of the cutter of FIG. 6.

FIG. 8 is an enlarged front perspective view of a cutting tooth of the cutter of FIG. 6.

FIG. 9 is an enlarged rear perspective view of the cutting tooth of FIG. 6.

FIG. 10 is a perspective view of a cutter according to another embodiment of the present invention.

FIG. 11 is an enlarged perspective view of a cutting tooth of the cutter of FIG. 10.

FIG. 12 is a perspective view of a cutter according to another embodiment of the present invention.

FIG. 13 is a perspective view of a cutter according to another embodiment of the present invention.

FIG. 14 is an enlarged rear perspective view of a cutting tooth of the cutter of FIG. 13.

FIG. 15 is an enlarged front perspective view of the cutting tooth of the cutter of FIG. 13.

FIG. 16 is a perspective view of a cutter according to another embodiment of the present invention.

FIG. 17 is a front view of the cutter of FIG. 16.

FIG. 18 is a side view of the cutter of FIG. 16.

FIG. 19 is a perspective view of a cutter according to another embodiment of the present invention.

FIG. 20 is a front view of the cutter of FIG. 19.

FIG. 21 is a side view of the cutter of FIG. 19.

FIG. 22 is a top view of the cutter of FIG. 19.

FIG. 23 is a perspective view of a cutter according to another embodiment of the present invention.

FIG. 24 is a side view of the cutter of FIG. 23.

FIG. 25 is a perspective view of a cutter according to another embodiment of the present invention.

FIG. 26 is a side view of the cutter of FIG. 25.

FIG. 27 is a perspective view of a cutter according to another embodiment of the present invention.

FIG. 28 is a flowchart depicting a method of manufacturing the chainsaw chain of FIG. 2.

FIG. 29 is a perspective view of a cutter according to another embodiment, the cutter including a feed limiter having a scoring tip.

FIG. 30 is a perspective view of a cutter according to another embodiment, the cutter including a feed limiter having a scoring tip and a cutting tooth having scoring tip.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

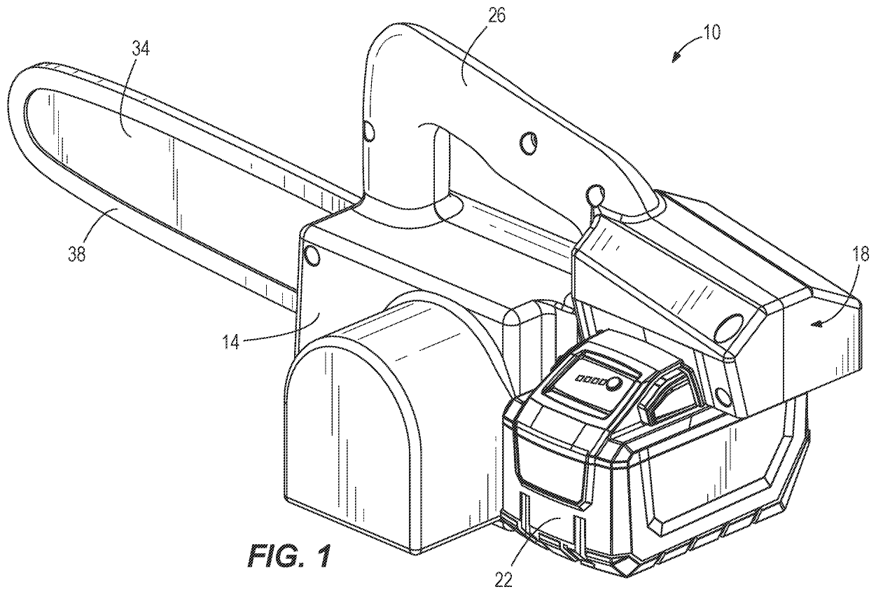

FIG. 1 illustrates a chainsaw 10 configured to perform cutting operations on a workpiece. The chainsaw 10 includes a housing 14 configured to support a motor and a drive mechanism, a battery receptacle 18 coupled to a rear portion of the housing 14, a power source 22 coupled to the battery receptacle 18, a handle 26 coupled to the housing 14 and the battery receptacle 18, a trigger coupled to the handle 26, and a guide bar 34 coupled to a front portion of the housing 14. In the illustrated embodiment, the power source 22 is a battery pack, such as an 18-volt Li-ion battery pack. The battery pack is configured to selectively supply power to the motor to activate the chainsaw 10. In other embodiments, the chainsaw 10 may have other types of power sources, such as a gasoline engine or an AC power cord. A chainsaw chain 38 is disposed along a periphery of the guide bar 34 and configured to be rotatably driven by the motor and the drive mechanism when the trigger is moved from an OFF position to an ON position. As the chainsaw chain 38 is driven along the guide bar 34, a user is able to perform cutting operations on material such as wood.

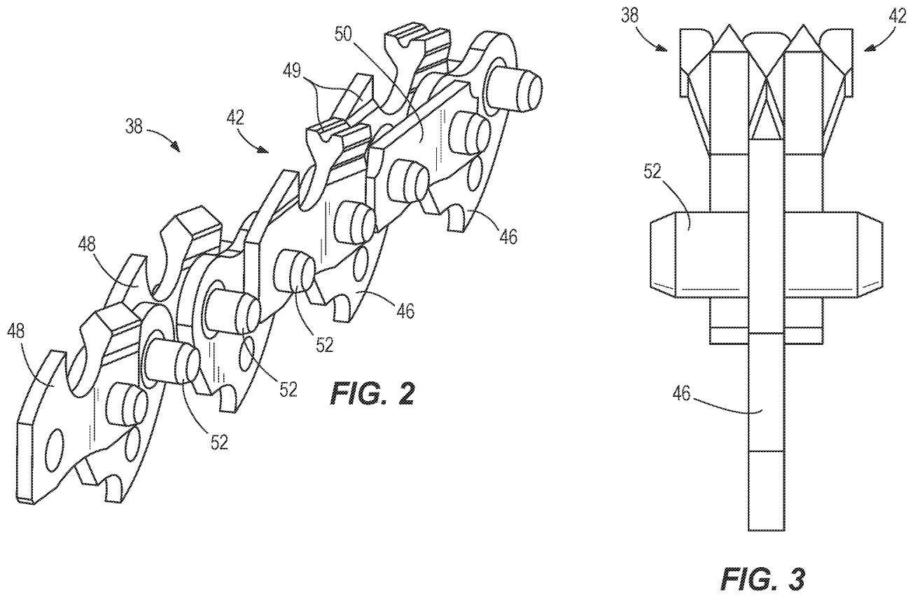

FIGS. 2 and 3 illustrate an embodiment of the chainsaw chain 38. The illustrated chainsaw chain 38 includes a plurality of cutters 42, a plurality of drive links 46 positioned at a central position of the chainsaw chain 38, and a plurality of tie straps 50 or tie links that interconnect consecutive drive links 46 of the plurality of drive links 46. In the illustrated embodiment, the plurality of cutters 42 includes a first set of cutters 48 and second set of cutters 49. In other embodiments, the plurality of cutters 42 may include a single set of cutters. The cutters 42, the drive links 46, and the tie straps 50 are each coupled to each other by rivets 52. The rivets 52 of FIGS. 2 and 3 are illustrated in an undeformed state. In some embodiments, the rivets 52 may undergo deformation to permanently couple the components of the chainsaw chain 38 together. In other embodiments, the cutters 42, the drive links 46 and the tie straps 50 may be coupled together by other suitable fasteners. The chainsaw chain 38 is formed by various cutting patterns defined by the positioning of the cutters 42, the drive links 46, and the tie straps 50. Although different constructions and configurations of cutters, drive links, and tie straps are discussed separately below, the cutters, drive links, and tie straps may be used in any combination to form a chainsaw chain. Features of one cutter, drive link, or tie strap are equally applicable to another cutter, drive link, or tie strap.

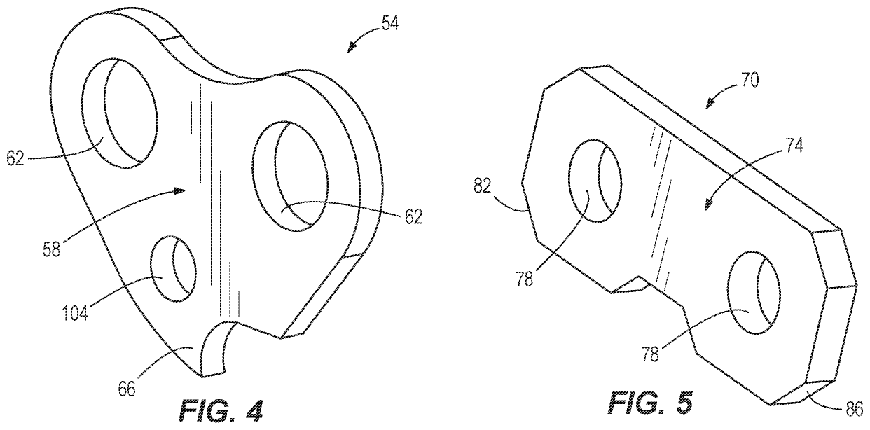

FIG. 4 illustrates one drive link 54 of the plurality of drive links 46. The drive link 54 includes a drive link body 58, one or more rivet holes 62 extending through the drive link body 58, and a tang 66 positioned below the pair of rivet holes 62. The rivet holes 62 are each configured to receive a rivet 52, so that the drive link 54 can be coupled to a cutter 42 and/or a tie strap 70 (FIG. 5). The tang 66 extends downwardly from the drive link body 58. In the illustrated embodiment, the tang 66 is integrally formed with the drive link body 58. In other embodiments, the tang 66 may be a separate piece that is secured to the drive link body 58. The tang 66 is defined by a curved gap formed within the drive link body 58 and is configured to support the chainsaw chain 38 along the guide bar 34 of the chainsaw 10. The tang 66 also engages a drive element moving within the guide bar 34 to drive the chainsaw chain 38 around the guide bar 34 and carry lubricating fluid (e.g., oil) through the guide bar 34 to keep the chainsaw chain 38 lubricated. The drive link 54 further includes an opening 104 proximate the tang 66. The opening 104 also carries and spreads lubricating fluid through the guide bar 34. In some embodiments, the drive link 54 includes a plurality of holes extending through the drive link body 58 to spread lubricating fluid. In other embodiments, the drive link 54 includes grooves embedded within the drive link body 58 to spread lubricating fluid. In still other embodiments, the drink link 54 may include other features to help spread lubricating fluid. Therefore, the chainsaw chain 38 can remain lubricated and attached to the guide bar 34 during operation of the chainsaw 10.

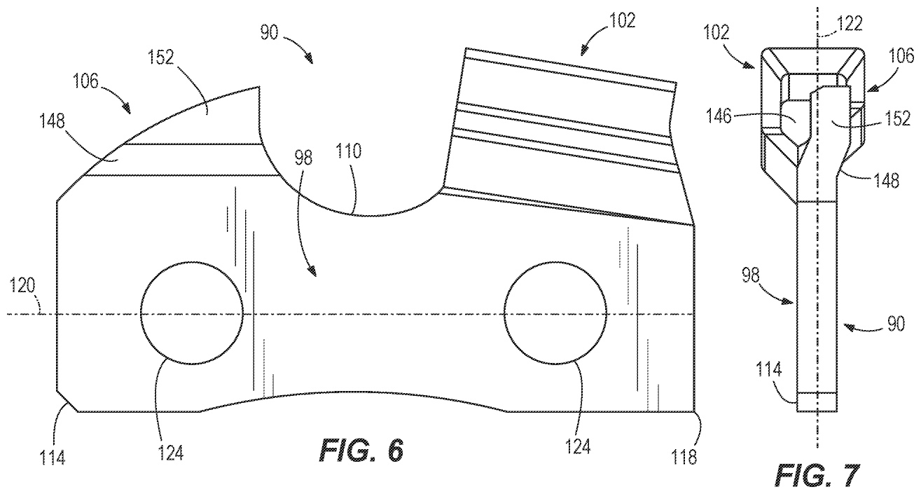

FIG. 5 illustrates one tie strap 70 of the plurality of tie straps 50. The tie strap 70 includes a tie strap body 74, one or more rivet holes 78 extending through the tie strap body 74, a toe 82, and a heel 86. The tie strap 70 is configured to interconnect the drive link 54 to a cutter 90 (FIG. 6) or consecutive drive links 46 to form the chainsaw chain 38. For example, one of the rivet holes 78 of the tie strap 70 may align with one of the rivet holes 62 of the drive link 54, while the other of the rivet holes 78 of the tie strap 70 may align with one of the rivet holes 94 of the cutter 90 (FIG. 6) or other cutters discussed herein.

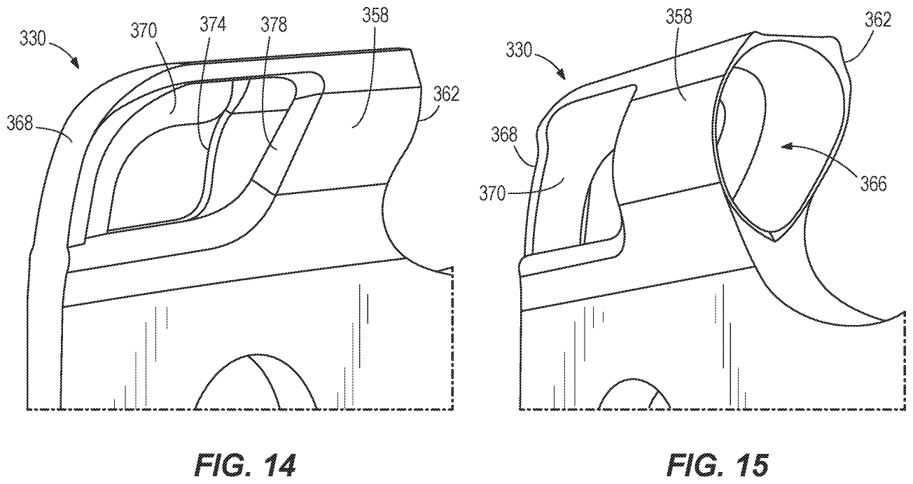

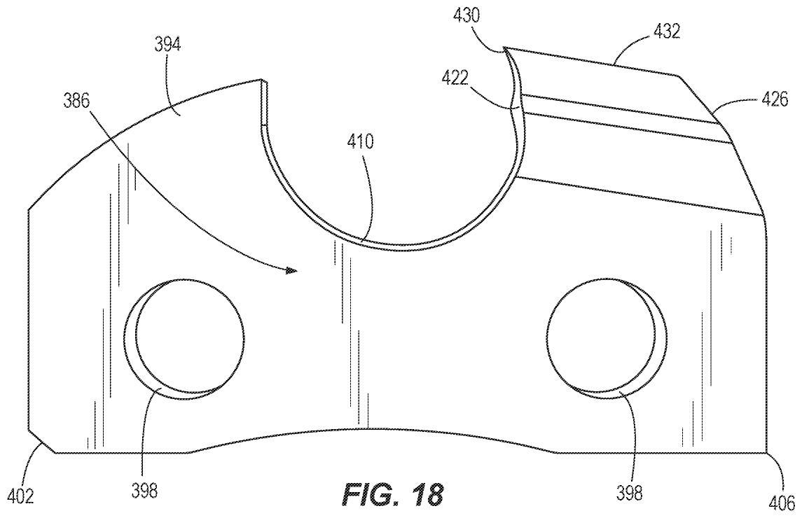

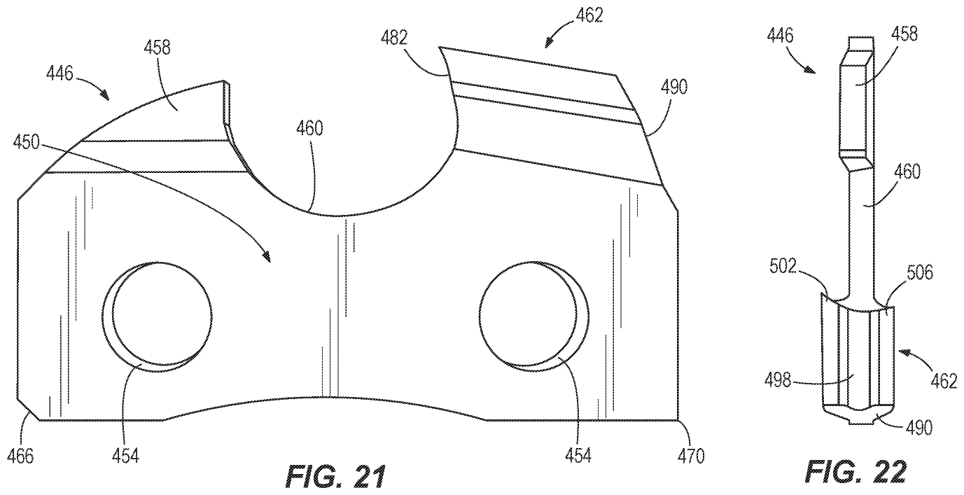

FIGS. 6-28 illustrate various embodiments of cutters for use with the chainsaw chain 38. The cutters have unique geometries that may be at least partially formed by, for example, additive manufacturing. The chainsaw chain 38 may include any or all of the cutters described below. In other words, the cutters may be used alone in a chainsaw chain (i.e., a chainsaw chain includes only one type of cutter) or may be used in any combination together (i.e., a chainsaw chain includes different types of cutters).

FIGS. 6-9 illustrate an embodiment of a cutter 90. The cutter 90 includes a cutter body 98, a cutting tooth 102, a feed limiter 106 or a depth gauge, a gullet 110, a toe 114, and a heel 118. The cutter body 98 defines a longitudinal axis 120 of the cutter 90, while a vertical axis 122 of the cutter 90 is oriented perpendicular to the longitudinal axis 120. The cutter 90 further includes one or more rivet holes 124 extending through the cutter body 98. Each rivet hole 124 is configured to receive a rivet 52. The longitudinal axis 120 of the cutter 90 extends through the rivet holes 124. The cutting tooth 102 is coupled to and extends from an upper portion of the cutter body 98. In the illustrated embodiment, the cutting tooth 102 is integrally formed with the cutter body 98. In other embodiments, the cutting tooth 102 may be a separate piece that is secured to the cutter body 98. The feed limiter 106 is also coupled to and extends from the upper portion of the cutter body 98. The feed limiter 106 is spaced apart from the cutting tooth 102 in front of the cutting tooth 102 in a cutting direction. In the illustrated embodiment, the feed limiter 106 is integrally formed with the cutter body 98. In other embodiments, the feed limiter 106 may be a separate piece that is secured to the cutter body 98. The feed limiter 106 is configured to limit how far the cutting tooth 102 can cut into a workpiece. The gullet 110 is defined between the cutting tooth 102 and the feed limiter 106. The toe 114 and the heel 118 are formed along a bottom portion of the cutter body 98. The toe 114 is positioned closer to the feed limiter 106, while the heel 118 is positioned closer to the cutting tooth 102. In the illustrated embodiment, the toe 114 is formed as a chamfer-like edge. In other embodiments, the heel 118 can also be formed as a chamfer-like edge.

The cutting tooth 102 of the cutter 90 is the portion of the chainsaw chain 38 that performs the cutting operation. The cutting tooth 102 may be formed by an additive manufacturing process, as described below. In some embodiments, the cutting tooth 102 may be a separate component that is secured to the cutter body 98 by various welding methods (e.g., brazing, resistance welding, laser welding, cladding, etc.). In other embodiments, the entire cutter 90, including the cutting tooth 102, may be formed by additive manufacturing. In some embodiments, the cutting tooth 102 may be ground (e.g., sharpened, etc.) to a desired shape or otherwise treated (e.g., heat treated, coated, etc.) after the cutting tooth 102 is formed on or secured to the cutter body 98.

Referring back to FIG. 2, the chainsaw chain 38 is formed by coupling the plurality of cutters 42 to the plurality of drive links 46, and also coupling the plurality of drive links 46 to the plurality of tie straps 50. One of the rivet holes 94 of the cutter 90 is aligned and coaxial with one of the rivet holes 62 of the drive link 54, so that a rivet 52 can be received through the aligned rivet holes 62, 94 of the drive link 54 and the cutter 90. The rivet 52 may be deformed to permanently couple the cutter 90 to the drive link 54. The same process can also be used to permanently couple the tie strap 70 and the drive link 54 together.

To deform the rivet 52 such that the cutter 90, the drive link 54, and the tie strap 70 are coupled to each other, the rivet 52 can be forged. The rivet 52 includes a rivet head having a first diameter, a rivet end opposite the rivet head, and a rivet shaft having a second diameter and disposed between the rivet head and the rivet end. Once the rivet 52 is received through corresponding rivet holes 62, 78, 94, either the drive link 54, the tie strap 70, or the cutter 90 is placed along the rivet shaft as the rivet head is positioned against a surface of either the cutter 90, the drive link 54, or the tie strap 70. The rivet end can then be deformed, such that the rivet end enlarges to a third diameter about two times larger than the second diameter of the rivet shaft. After the rivet end has been deformed, the cutter 90, the drive link 54, and the tie strap 70 are then enclosed between the rivet head and the rivet end and permanently coupled to each other.

Referring back to FIGS. 6-9, the cutting tooth 102 of the cutter 90 is defined as a squared loop formed by a top wall 132, a first side wall 136, a second side wall 140 disposed opposite the first side wall 136, and a bottom wall 144 integrally formed with the first and second side walls 136, 140. The first and second side walls 136, 140 extend from respective ends of the top wall 132. The bottom wall 144 forms a L-shape to define a long portion and a short portion, in which the long portion of the bottom wall 144 is integrally formed with the upper portion of the cutter body 98. As such, the squared loop forms a hollow configuration which defines a channel 146 extending therethrough. The squared loop further includes a leading edge 150 having a chamfer-like surface and defined at a front portion of the cutting tooth 102. The squared loop may also be considered a polygonal loop.

The feed limiter 106 of the cutter 90 includes a first elongated portion 148 integrally formed with the cutter body 98 and oriented at an oblique angle relative to the cutter body 98 and the vertical axis 122 of the cutter 90. The feed limiter 106 further includes a second elongated portion 152 integrally formed with the first elongated portion 148 of the feed limiter 106. The second elongated portion 152 extends in a direction parallel to the vertical axis 122. As such, the second elongated portion 152 of the feed limiter 106 is offset from the cutter body 98. In the illustrated embodiment, the first elongated portion 148 of the feed limiter 106 is oriented (i.e., bent) in a right direction. In other embodiments, the first elongated portion 148 of the feed limiter 106 is oriented in a left direction.

When the chainsaw 10 is performing cutting operations, the leading edge 150 of the squared loop begins the cutting operations by contacting a workpiece. As the cutter 90 continues to be driven along the workpiece, the top wall 132 finishes the cutting operation by completely removing material from the workpiece. With the hollow configuration, the squared loop can reduce clogging of the chainsaw chain 38 by directing removed material into the channel 146 and away from the work area.

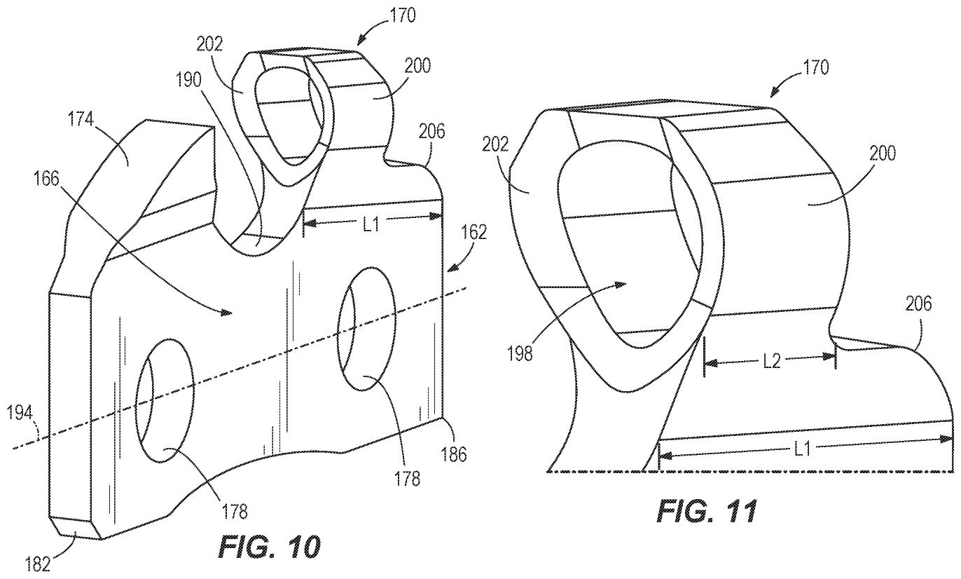

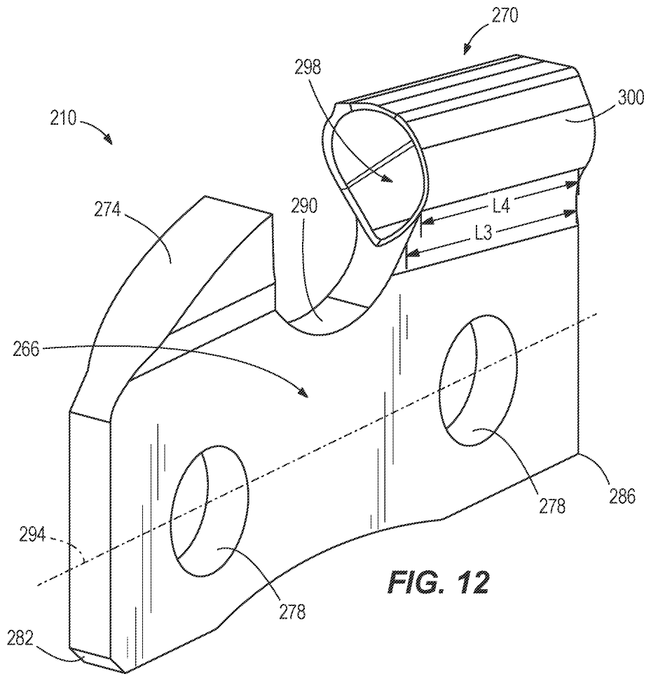

FIGS. 10 and 11 illustrate another embodiment of a cutter 162. The cutter 162 include a cutter body 166, a cutting tooth 170, a feed limiter 174, one or more rivet holes 178, a toe 182, a heel 186, and a gullet 190 positioned between the feed limiter 174 and the cutting tooth 170. A longitudinal axis 194 of the cutter 162 is defined along the cutter body 166 and extends through the rivet holes 178. The cutting tooth 170 is coupled to an upper portion of the cutter body 166 and has a first length L1 defining a length at which the cutting tooth 170 extends across the cutter body 166. At least a portion of the feed limiter 174 extends outward, such that the feed limiter 174 has a width that is the same as a width defined by the cutting tooth 170. In other embodiments, the feed limiter 174 is wider than the cutting tooth 170.

The cutting tooth 170 of the cutter 162 includes a circular or rounded loop 200 through which a channel 198 extends. A leading edge 202, formed at a front portion of the circular loop 200, has a chamfer-like surface. The circular loop 200 defines a second length L2 that is less than the first length L1 of the cutting tooth 170. As such, the circular loop 200 is positioned along a front portion of the cutting tooth 170, while a curved edge 206 is defined along a rear portion of the cutting tooth 170. Since the circular loop 200 defines a hollow configuration, the cutting tooth 170 can help remove debris from the work area while performing cutting operations. During operation, material that has been removed from a workpiece can travel through the channel 198 so that removed material is directed away from the chainsaw chain 38 to reduce clogging.

Referring to FIG. 12, another embodiment of a cutter 210 is illustrated. The cutter 210 is similar to the cutter 162 of FIGS. 10 and 11; therefore, like structure will be identified by like reference number plus “100” and only the differences will be discussed hereafter.

In the embodiment of FIG. 12, the cutting tooth 270 has a third length L3 which defines a length at which the cutting tooth 270 extends along an upper portion of the cutter body 266. The circular loop 300 of the cutting tooth 270 defines a fourth length L4 which is substantially equal to the third length L3 of the cutting tooth 270. As such, the circular loop 300 extends along the entire length of the cutting tooth 270.

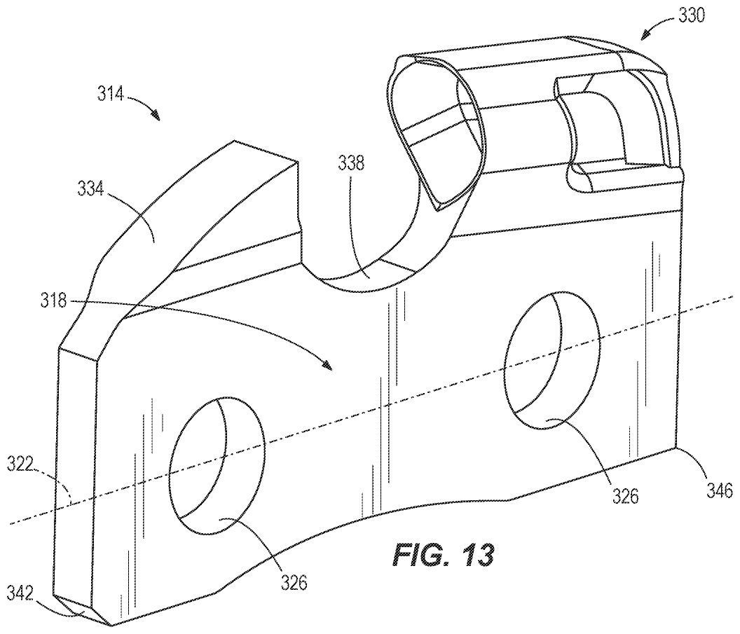

FIGS. 13-15 illustrate another embodiment of a cutter 314. The cutter 314 includes a cutter body 318 defining a longitudinal axis 322 of the cutter 314, one or more rivet holes 326, a cutting tooth 330, a feed limiter 334, a gullet 338, a toe 342, and a heel 346. The one or more rivet holes 326 extend through the cutter body 318. The longitudinal axis 322 of the cutter 314 extends through the rivet holes 326. The feed limiter 334 and the cutting tooth 330 are integrally formed along an upper portion of the cutter body 318 and opposite each other with the gullet 338 positioned therebetween. The feed limiter 334 has a portion that extends outward, such that a width of the feed limiter 334 is the same as a width of the cutting tooth 330 to correspond to the size of the cutting tooth 330. In other embodiments, the feed limiter 174 is wider than the cutting tooth 170.

The cutting tooth 330 of the cutter 314 includes a circular or rounded loop 358 having a leading edge 362 defining an opening in communication with a channel 366 extending through the circular loop 358. The circular loop 358 is disposed at a front portion of the cutting tooth 350. The cutting tooth 330 further includes an outer wall 368 integrally formed with the circular loop 358 and the cutter body 318, in which the outer wall 368 has a curved profile. Specifically, the outer wall 368 is coupled with a top portion of the circular loop 358 and the upper portion of the cutter body 318 at a rear portion of the cutting tooth 330. An inner wall 370 extends along an inner surface of the outer wall 368 and within an interior of the cutting tooth 330. The cutting tooth 330 also includes a first opening 374 and a second opening 378 opposite the first opening 374. The first and second openings 374, 378 are respectively defined between the circular loop 358 and the outer wall 368. In addition, the inner wall 370 is disposed between the first and second openings 374, 378.

During operation, the leading edge 362 of the cutting tooth 330 starts the cutting operation, while an outer surface of the circular loop 358 finishes the cutting operation by removing material from a work surface. The hollow configuration of the cutting tooth 330 helps clear debris or removed material from the work area and reduce clogging the chainsaw chain 38 with debris. The debris can pass through the channel 366 of the circular loop 358 and exit through either the first opening 374 or the second opening 378. The debris can also pass along the outer surface of the circular loop 358.

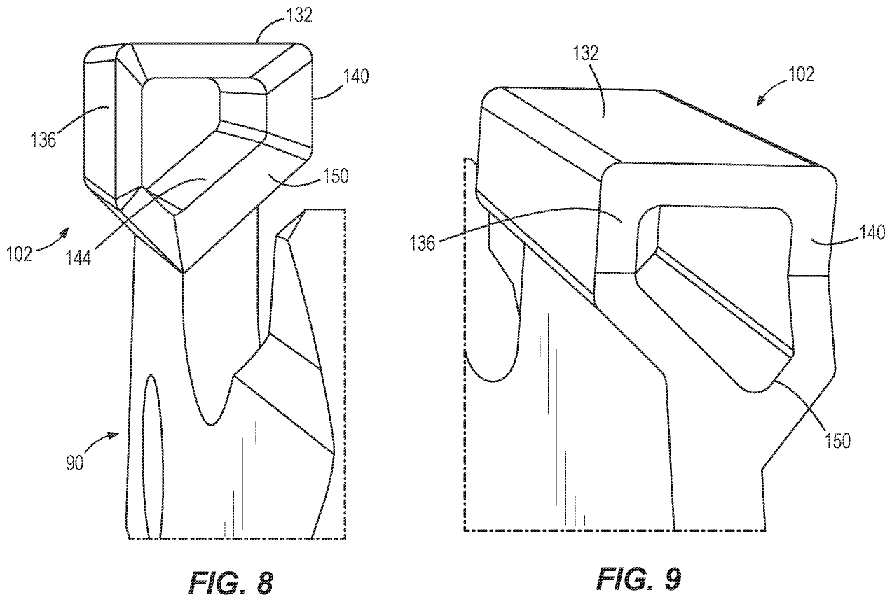

In the embodiments of FIGS. 6-15, the cutters 90, 162, 210, 314 are chisel chainsaw cutters. Specifically, the squared loop of the cutter 90, illustrated in FIGS. 6 and 7, forms squared corners to provide a rectangular profile that is similar to a full-chisel chainsaw cutter. As such, the cutter 90 can be used in, but not limited to, professional settings to produce clean and efficient cuts. The cutters 162, 210, 314 of FIGS. 8-11 have rounded corners to form a circular profile that is similar to a semi-chisel chainsaw cutter. The cutters 162, 210, 314 can be used for, but not limited to, home improvements.

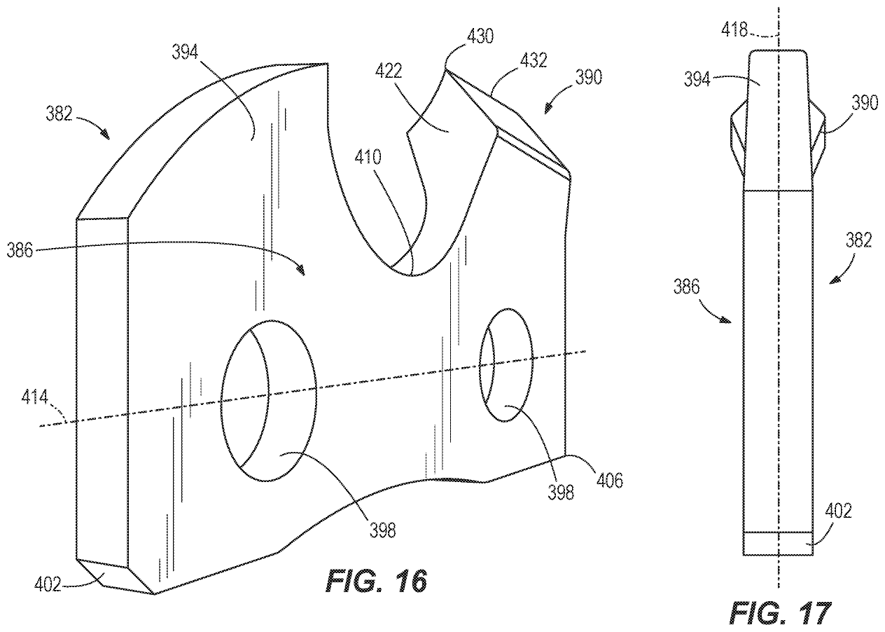

FIGS. 16-18 illustrate another embodiment of a cutter 382. The cutter 382 includes a cutter body 386, a cutting tooth 390, a gullet 392, a feed limiter 394, one or more rivet holes 398 extending through the cutter body 386, a toe 402, and a heel 406. The cutting tooth 390 and the feed limiter 394 are integrally formed with an upper portion of the cutter body 386. The cutter 382 further includes a gullet 410 disposed between the cutting tooth 390 and the feed limiter 394. The cutter body 386 defines a longitudinal axis 414 of the cutter 382 and a vertical axis 418 oriented perpendicular to the longitudinal axis 414. The longitudinal axis 414 of the cutter 382 extends through the rivet holes 398.

The cutting tooth 390 of the cutter 382 includes a rake face 422 formed at a first end of the cutting tooth, a relief face 426 formed at a second end of the cutting tooth 390 opposite the first end, and a cutting tip 430 formed on the rake face 422. A cutting edge 432 is formed between the rake face 422 and the relief face 426. The illustrated cutting tooth 390 forms a diamond-shaped structure in which the edges along the rake face 422 serve as cutting elements.

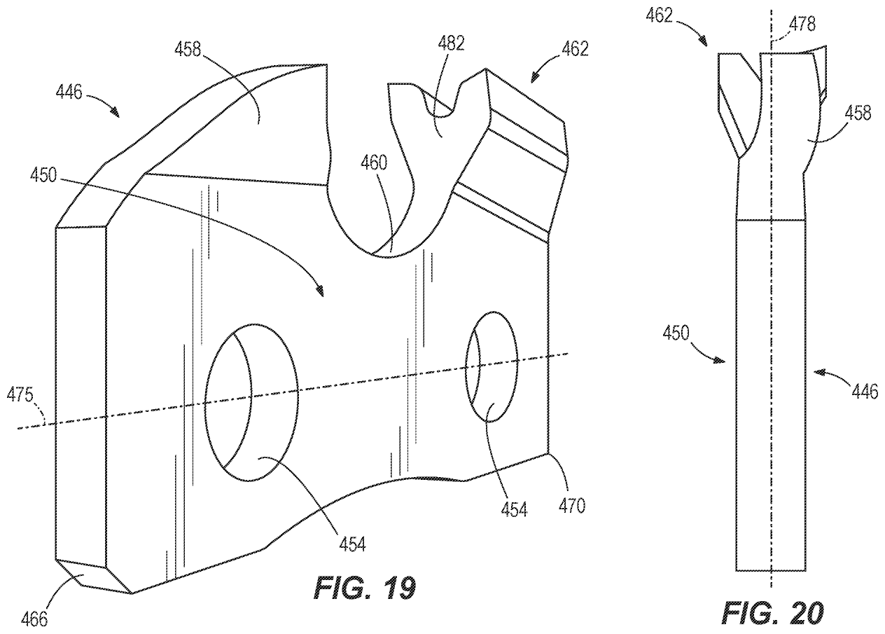

FIGS. 19-22 illustrate another embodiment of a cutter 446. The cutter 446 includes a cutter body 450, one or more rivet holes 454 extending through the cutter body 450, a feed limiter 458 integrally formed with the cutter body 450, a cutting tooth 462 integrally formed with the cutter body 450 opposite the feed limiter 458, a gullet 460, a toe 466, and a heel 470. A longitudinal axis 474 of the cutter 446 is defined by the cutter body 450 and a vertical axis 478 of the cutter 446 oriented perpendicular to the longitudinal axis 474. In addition, the longitudinal axis 474 of the cutter 446 extends through the rivet holes 454. The feed limiter 458 is offset from the vertical axis 478, such that at least a portion of the feed limiter 458 is oriented at an oblique angle relative to the vertical axis 478.

The cutting tooth 462 of the cutter 446 includes a rake face 482 at a first end of the cutting tooth 462 and a relief face 490 at a second end of the cutting tooth 462 opposite the first end. The illustrated cutting tooth 462 forms a Y-shaped profile having a groove 498 that is defined along a length of the cutting tooth 462. The groove 498, which extends along a top portion of the cutting tooth 462, defines a first cutting tip 502 and a second cutting tip 506 at a front portion of the cutting tooth 462.

Referring back to FIGS. 2 and 3, in some configurations, the first set of cutters 48 of the plurality of cutters 42 may include the cutter 382 of FIGS. 16-18 and the second set of cutters 49 of the plurality of cutters 42 may include the cutter 446 of FIGS. 19-21. The plurality of cutters 42 are positioned along each side of respective drive links 46, as the drive links 46 are positioned along a central portion of the chainsaw chain 38. As such, the chainsaw chain 38 has a cutting pattern in which the first set of cutters 48 alternates with the second set of cutters 49.

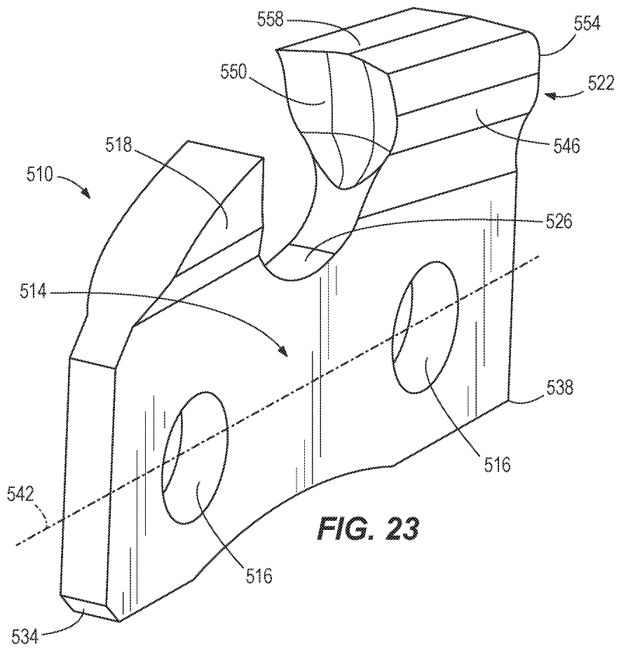

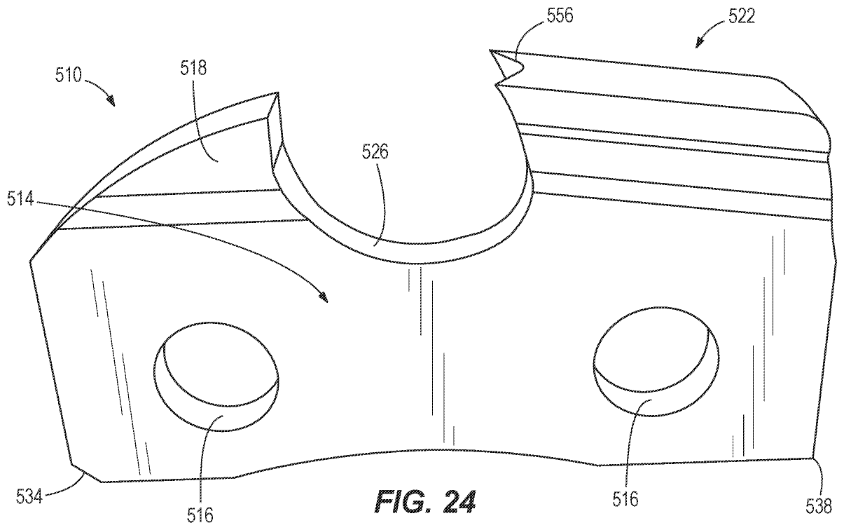

With reference to FIGS. 23 and 24, another embodiment of a cutter 510 is illustrated. The cutter 510 includes a cutter body 514, one or more rivet holes 516 extending through the cutter body 514, a feed limiter 518 integrally formed along a top portion of the cutter body 514, a cutting tooth 522 integrally formed along the top portion of the cutter body 514 opposite the feed limiter 518, and a gullet 526 formed within the cutter body 514 and between the cutting tooth 522 and the feed limiter 518. The cutter 510 further includes a toe 534 and a heel 538, both formed at a bottom portion of the cutter body 514 and opposite each other. The cutter body 514 defines a longitudinal axis 542 of the cutter 510 that extends through the rivet holes 516.

The cutting tooth 522 of the cutter 510 includes a cutting tooth body 546 with a rake face 550, a relief face 554, and a cutting surface 558 extending between the rake face 550 and the relief face 554. The rake face 550 is formed at a first end of the cutting tooth body 546 proximate the gullet 526. The relief face 554 is positioned at a second end of the cutting tooth body 546 opposite the first end. The rake face 550 is concave. In addition, the rake face 550 forms a wide profile that covers a cross-section of the guide bar 34. Moreover, the rake face 550 forms a cutting edge 556 that extends into the cutting tooth body 546 and has an arcuate form. To correspond to the size of the cutting tooth 522, the feed limiter 518 has a portion that expands outward.

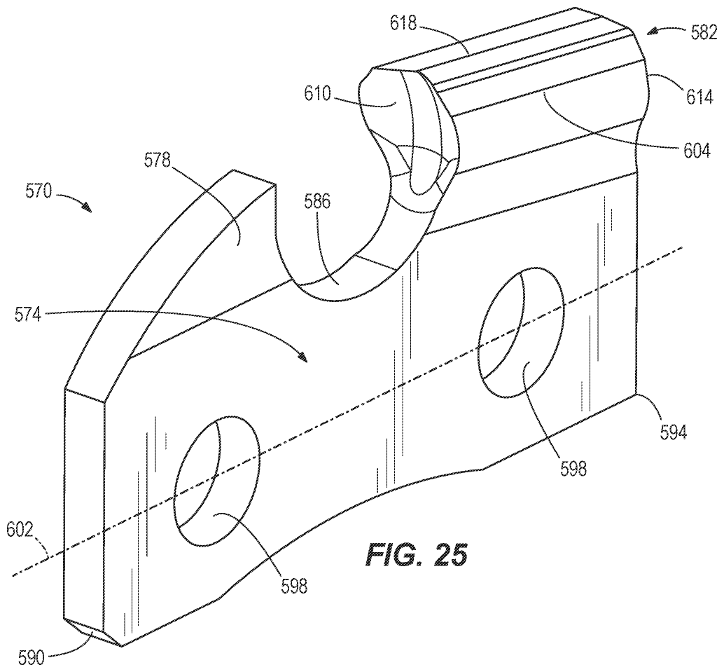

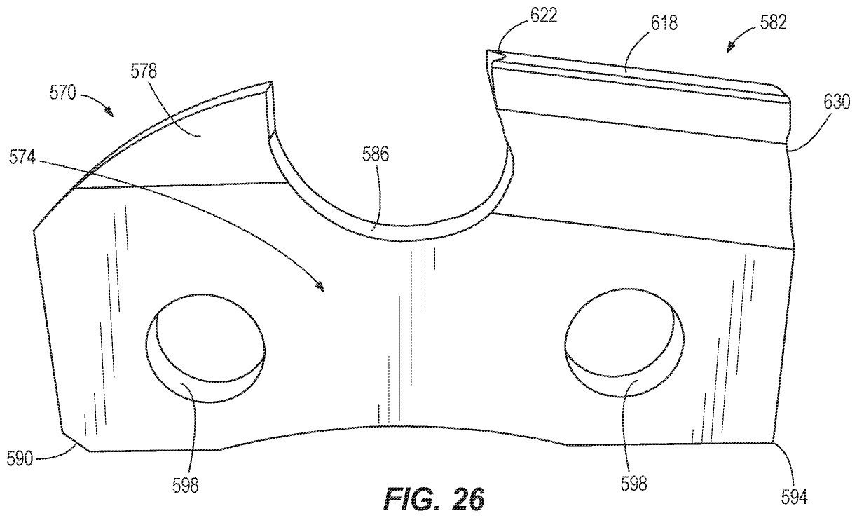

FIGS. 25 and 26 illustrate another embodiment of a cutter 570. The cutter 570 includes a cutter body 574, a feed limiter 578, a cutting tooth 582, a gullet 586 disposed between the feed limiter 578 and the cutting tooth 562, a toe 590, and a heel 594. The feed limiter 578, the cutting tooth 582, and the gullet 586 are formed within the cutter body 574. The cutter 570 further includes one or more rivet holes 598 extending through the cutter body 574. The cutter body 574 defines a longitudinal axis 602 that extends through the rivet holes 598.

The cutting tooth 582 of the cutter 570 includes a cutting tooth body 604 with a rake face 610 formed at a first end of the body 604, a relief face 614 formed at a second end of the body 604 opposite the first end, and a cutting surface 618 extending between the rake face 610 and the relief face 614. The rake face 610 is defined as a concave surface and includes a cutting edge 622 that protrudes into the cutting tooth body 604. The relief face 614 includes an angular indentation 630.

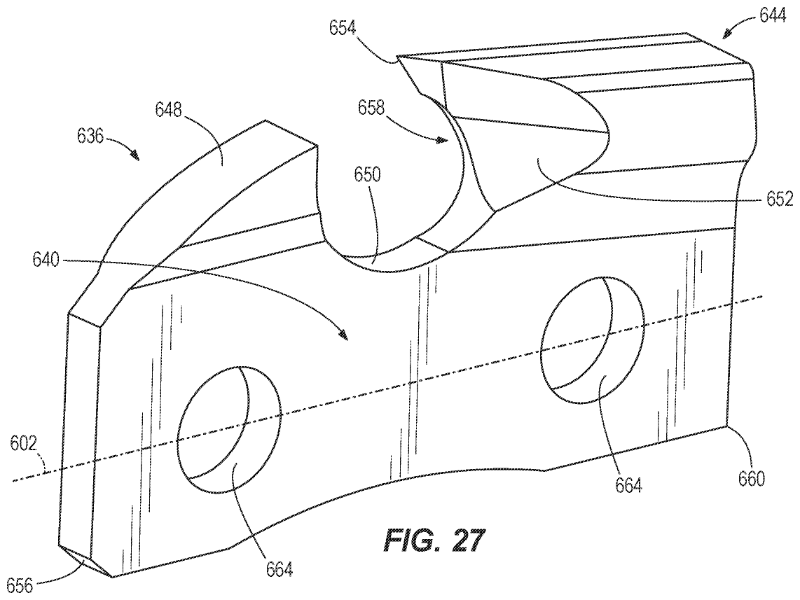

FIG. 27 illustrates another embodiment of a cutter 636. The cutter 636 includes a cutter body 640, a cutting tooth 644 formed at a top portion of the cutter body 640, a feed limiter 648 also formed at the top portion of the cutter body 640 and opposite the cutting tooth 644, a gullet 650 formed within the cutter body 640 and disposed between the cutting tooth 644 and the feed limiter 648, a toe 656, and a heel 660. The toe 656 and the heel 660 are formed at a bottom portion of the cutter body 640. The cutter 636 further includes one or more rivet holes 664 extending through the cutter body 640. A longitudinal axis 665 of the cutter 636 is defined by the cutter body 640 and extends through the rivet holes 664.

The cutting tooth 644 of the cutter 636 includes a cutting tip 654 formed at a first end of the cutting tooth 644, a first rake surface 652, and a second rake surface 658. The cutting tip 654 is defined between the first and second rake surfaces 652, 658 such that the first rake surface 652 is formed opposite the second rake surfaces 658. The first and second rake surfaces 652, 658 have a concave surface. The cutting tooth 644 forms a width that covers the cross-section of the guide bar 34. At least a portion of the feed limiter 648 protrudes outward to correspond to the width of the cutting tooth 644.

With reference to FIGS. 6-27, each cutting tooth 102, 170, 270, 330, 390, 462, 522, 582, 644 can be coupled to (e.g., formed on) the cutter body of each cutter by an additive manufacturing process, such as 3D printing. Specifically, each cutting tooth illustrated in the embodiments of FIGS. 6-24 is made by adding layer-upon-layer of metal material to create the profile of the cutting teeth. To create each cutting tooth, using 3D printing, a 3D drawing of the cutting tooth may be produced in a computer aided design (CAD) software program. Then, a printing machine reads data from the CAD file and lays down or adds successive layers of liquid powder metals in a layer-upon-layer fashion to fabricate the cutting tooth.

By using additive manufacturing, the cutting teeth may be formed without having to grind the cutting teeth to a desired shape after a cutting tooth has been permanently coupled to a cutter body of a cutter. This process helps reduce costs by not wasting excess material. In addition, the shape of each cutting tooth can be more precisely designed.

In some embodiment, after the additive manufacturing process, the cutting tip or the cutting edge of a cutting tooth may be cladded (e.g., laser cladded) to add strength to the cutting tooth. During the cladding procedure, a system is configured to supply a granular or powder material along the outer surface of the cutting tip or the cutting edge of a cutting tooth. An energy source, within the system, applies heat to the powder material and a target area of the cutting tooth. The energy source also provides a laser beam configured to be positioned on the target area of the cutting tooth. The heat applied by the energy source melts the powder material and the target area of the cutting tooth such that the powder material and the cutting tooth fuse together as the laser beam passes along the target area of the cutting tooth. As a result, the cutting tooth and the powder material forms a bonded coating layer. The cutting tooth is arranged to be movable relative to the system.

In some embodiments, whether with or without cladding, the cutter is then heat treated at a desired setting. Heat treatment helps harden the entire cutter or portions of the cutter to desired specifications. After heat treating, the cutter is ground to its final form by sharpening edges and/or removing imperfections on the cutter. In other embodiments, the cutter can be in a final form, without undergoing a grinding process after heat treating.

In some embodiments, each cutting tooth 102, 170, 270, 330, 390, 462, 522, 582, 644 or the entire profile of each cutter 90, 162, 210, 314, 382, 446, 510, 570, 636 can be formed by an additive manufacturing process, such as selective laser sintering (SLS). Specifically, a laser is used to sinter powdered metal to create the profile of the cutting teeth. During the process, a cross-section, defined within a 3D drawing of the cutting tooth, is outlined by the laser to form a single layer of the cutting tooth on a powder bed. The powder bed is then lowered so that a fresh layer of powdered material can be outlined across the powder bed. As such, another cross-section of the cutting tooth can be formed by the laser. The cross-section of the cutting tooth varies throughout the process to create the final form of the cutting tooth. Once the cutting tooth is formed, then the cutting tooth can be attached to the cutter body of a cutter by various welding methods (e.g., brazing, resistance welding, laser welding, cladding, etc.). Other additive manufacturing processes, such as electron-beam additive manufacturing or selective laser melting can also be used to form each cutting tooth 102, 170, 270, 330, 390, 462, 522, 582, 644.

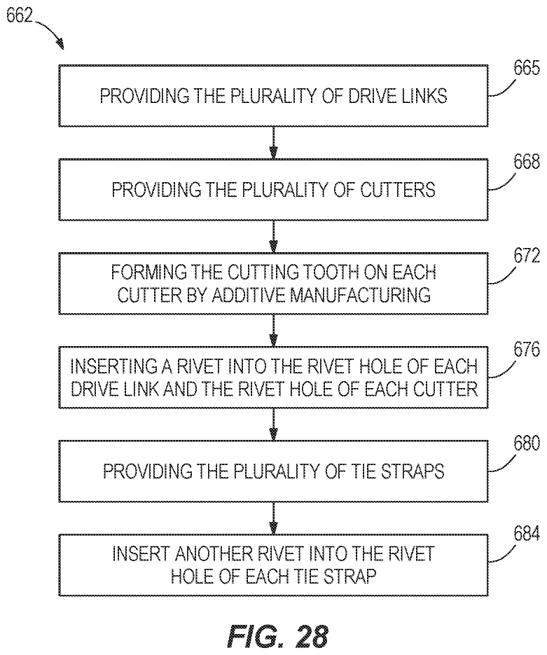

FIG. 28 depicts a method 662 of manufacturing the chainsaw chain 38 of FIG. 2. At step 665, the plurality of drive links 46 is provided. The plurality of drive links 46 is configured to engage the drive element of the chainsaw 10 to connect the chainsaw chain 38 to the chainsaw 10. Each drive link 46 may take the form of, for example, the drive link 54 of FIG. 4. At step 668, the plurality of cutters 42 is provided to cut a workpiece during a cutting operation. Each cutter 42 may take the form of, for example, the cutters 90, 162, 210, 314, 382, 446, 510, 570, 636 of FIGS. 6-27. In other embodiments, each cutter 42 may take the form of other cutters discussed herein. At step 672, the cutting tooth is formed on each cutter 42 by additive manufacturing. Various additive manufacturing processes discussed herein may be used to form the cutting tooth of each cutter 42. Each cutting tooth may take the form of, for example, the cutting tooth 102, 170, 270, 330, 390, 462, 522, 582, 644 of FIG. 6-27. In other embodiments, each cutting tooth may take the form of other cutting teeth discussed herein.

At step 676, a rivet 52 is inserted into the rivet hole 62 of each drive link 46 and the rivet hole of each cutter 42 to couple the plurality of drive links 46 and the plurality of cutters 42 together. At step 680, the plurality of tie traps 50 is provided. Each tie strap 50 may take the form of, for example, the tie strap 70 of FIG. 5. At step 684, another rivet 52 is inserted into the rivet 78 of each tie strap 60 to couple the plurality of drive links 46, the plurality of cutters 42, and the plurality of tie straps 60 together. In some embodiments, the step 676 and the step 684 may be combined into a single step.

In some embodiments, the method 662 may not include all of the steps described above or may include additional steps before, after, or between the depicted steps. In addition, the steps may be performed in other orders.

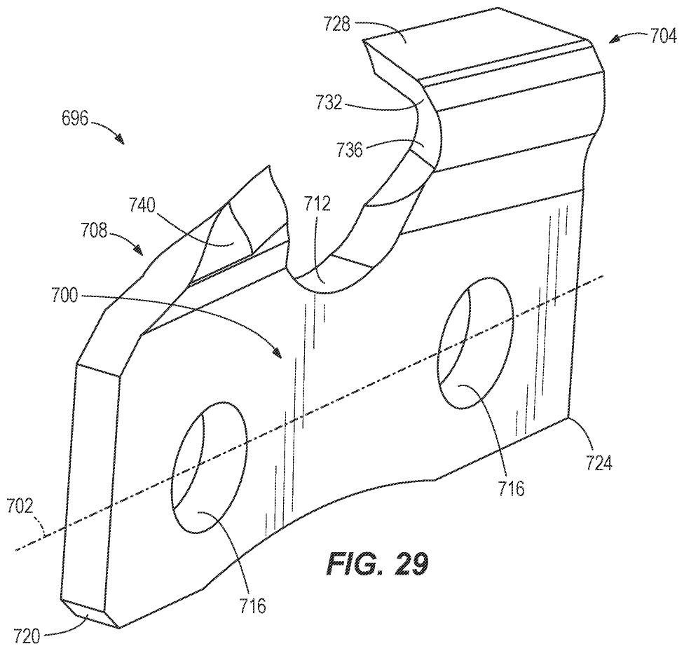

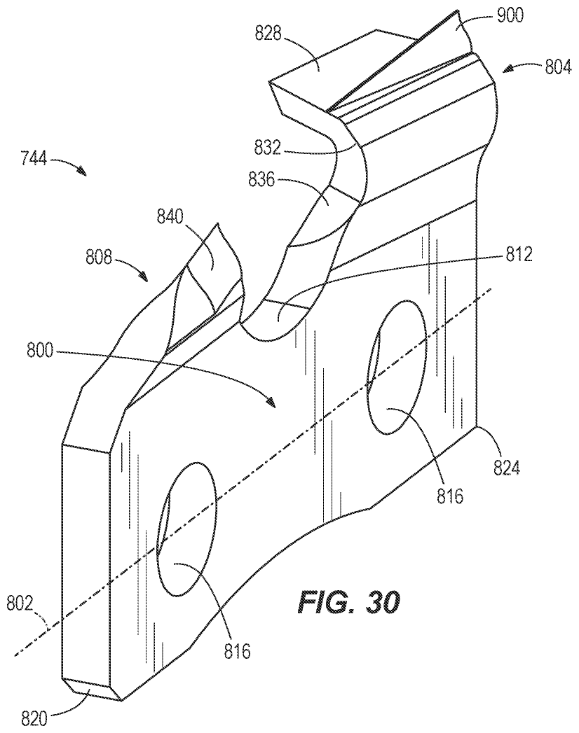

FIG. 29 illustrates another embodiment of a cutter 696. The cutter 696 includes a cutter body 700, a longitudinal axis 702 defined by the cutter body 700, a cutting tooth 704, a feed limiter 708, a gullet 712, one or more rivet holes 716 extending through the cutter body 700, a toe 720, and a heel 724. The longitudinal axis 702 of the cutter 696 extends through the rivet holes 716. The cutting tooth 704 and the feed limiter 708 are integrally formed with a top portion of the cutter body 700. The gullet 712 is disposed between the cutting tooth 704 and the feed limiter 708. The toe 720 and the heel 724 are formed at a bottom portion of the cutter body 700.

The cutting tooth 704 of the cutter 696 includes a top plate 728 oriented perpendicular to the cutter body 700, a lead edge 732 defining a rounded cutting corner, and a side plate 736. Specifically, the lead edge 732 and the side plate 736 are defined along a side of the top plate 728 proximate the gullet 712. In other embodiments, the lead edge 732 can be defined as a squared cutting corner. The lead edge 732 is configured to be the first portion of the cutting tooth 704 that contacts a workpiece to begin the cutting operation by cutting into a workpiece. The side plate 736 and the top plate 728 are provided to finish the cutting operation of the cutter 696 by completely cutting material of the workpiece.

The feed limiter 708 of the cutter 696 includes a scoring tip 740 configured to be driven over a fastener (e.g., a nail, etc.) or other hard object fixed into a workpiece. As the cutter 696 is driven along the workpiece, the scoring tip 740 of the feed limiter 708 is the first portion of the cutter 696 to contact the fastener. When the scoring tip 740 contacts the nail, the cutter 696 is repositioned such that a small portion of the lead edge 732 and the side plate 736 of cutting tooth 704 contacts the nail to inhibit the cutting tooth 704 from fracturing. As a chainsaw chain including a plurality of cutters, similar to the cutter 696 of FIG. 29, is driven along the workpiece, the fastener fixed into the workpiece is weakened and broken down by continuously contacting the scoring tip 740.

The feed limiter 708 of the cutter 696 may be integrally formed along the top portion of the cutter body 700 by various welding methods, such as brazing. In other embodiments, the feed limiter 708 may be formed on the cutter body 700 by additive manufacturing. Once the feed limiter 708 is secured to the cutter body 700, the feed limiter 708 can be ground to a desired shape to form the scoring tip 740 of the feed limiter 708. In this case, the feed limiter 708 is ground so that the scoring tip 740 has a sharp end for weakening a fastener within a workpiece.

Referring to FIG. 30, another embodiment of a cutter 744 is illustrated. The cutter 744 is similar to the cutter 696 of FIG. 29; therefore, like structures will be identified by like reference numbers plus “100” and only the differences will be discussed hereafter.

The cutting tooth 804 of the cutter 744 includes a second scoring tip 900 integrally formed with the top plate 828 and extending away from the top plate 828. The second scoring tip 900 is also configured to contact and weaken a fastener within a workpiece, like the scoring tip 740 of the feed limiter 708 in FIG. 29. As such, the second scoring tip 900 is provided to further reposition the cutter 744 and ultimately a chainsaw chain, after the top plate 828 has finished the cutting action of the cutter 744. The second scoring tip 900 may be formed on the top plate 828 by an additive manufacturing process as discussed herein above.

Although the invention has been described in detail with reference to certain preferred embodiments, variations and modifications exist within the scope and spirit of one or more independent aspects of the invention as described. Various features and advantages of the invention are set forth in the following claims.

What is claimed is:

1. A chainsaw cutter for a chainsaw chain, the chainsaw cutter comprising:
a cutter body having a pair of rivet holes extending through the cutter body;
a cutting tooth coupled to and extending from an upper portion of the cutter body, the cutting tooth configured to cut a workpiece during a cutting operation;
a feed limiter coupled to and extending from the upper portion of the cutter body, the feed limiter spaced from the cutting tooth; and
a gullet disposed between the cutting tooth and the feed limiter,
wherein the cutting tooth is formed on the cutter body by additive manufacturing.

2. The chainsaw cutter of claim 1, wherein the cutting tooth is at least partially defined as a loop through which a channel extends.

3. The chainsaw cutter of claim 2, wherein the loop includes a leading edge having a chamfer-like surface.

4. The chainsaw cutter of claim 2, wherein the loop is a polygonal loop.

5. The chainsaw cutter of claim 2, wherein the loop is a rounded loop.

6. The chainsaw cutter of claim 2, wherein the cutting tooth includes a wall coupled to a top of the loop and the upper portion of the cutter body, and an opening defined between the loop and the wall.

7. The chainsaw cutter of claim 1, wherein the cutting tooth forms a diamond-shaped structure.

8. The chainsaw cutter of claim 1, wherein the cutting tooth forms a Y-shaped profile having a groove extending along a length of the cutting tooth.

9. The chainsaw cutter of claim 1, wherein the cutting tooth includes a rake face proximate the gullet, and wherein the rake face is concave.

10. The chainsaw cutter of claim 1, wherein the cutting tooth includes a first rake surface on a first side of the cutter body, a second rake surface on a second side of the cutter body, and a cutting tip defined between the first rake surface and the second rake surface.

11. The chainsaw cutter of claim 1, wherein the feed limiter includes a scoring tip.

12. The chainsaw cutter of claim 1, wherein the cutting tooth includes a scoring tip.

13. A chainsaw chain for a chainsaw, the chainsaw chain comprising:
a plurality of drive links configured to connect the chainsaw chain to the chainsaw, each drive link including a drive link body, a rivet hole extending through the drive link body, and a tang extending from the drive link body and configured to engage a drive element of the chainsaw chain;
a plurality of cutters configured to cut a workpiece during a cutting operation, wherein at least one of the plurality of cutters is the chainsaw cutter of claim 1; and
a plurality of rivets received within corresponding rivet holes of the plurality of drive links and the plurality of cutters to couple the plurality of drive links and the plurality of cutters together.

14. The chainsaw chain of claim 13, further comprising a plurality of tie straps, wherein each tie strap includes a tie strap body and rivet hole extending through the tie strap body, and wherein the plurality of rivets is also received within corresponding rivet holes of the plurality of tie straps to couple the plurality of drive links, the plurality of cutters, and the plurality of tie straps together.

15. A method of manufacturing a chainsaw chain for a chainsaw, the method comprising:
providing a plurality of drive links, each drive link including a drive link body, a rivet hole extending through the drive link body, and a tang extending from the drive link body and configured to engage a drive element of the chainsaw;
providing a plurality of cutters, each cutter including a cutter body having a rivet hole extending therethrough;
forming a cutting tooth on the cutter body of at least one of the plurality of cutters by additive manufacturing; and
inserting a rivet into the rivet hole of each drive link and the rivet hole of each cutter to couple the plurality of drive links and the plurality of cutters together.

16. The method of claim 15, wherein forming the cutting tooth on the cutter body of the at least one of the plurality of cutters includes one or more selected from a group consisting of forming the cutting tooth by three-dimensional printing, forming the cutting tooth by selective laser sintering, forming the cutting tooth by electron-beam additive manufacturing, and forming the cutting tooth be selective laser melting.

17. The method of claim 15, further comprising grinding the at least one of the plurality of cutters to a desired shaped.

18. The method of claim 15, further comprising heat treating the at least one of the plurality of cutters.

19. The method of claim 15, further comprising welding the cutting tooth of the at least one of the plurality of cutters to the cutter body.

20. The method of claim 15, further comprising
providing a plurality of tie straps, each tie strap including a tie strap body and a rivet hole extending therethrough; and
inserting a rivet into the rivet hole of each tie strap to couple the plurality of drive links, the plurality of cutters, and the plurality of tie straps together.
